(19) United States
(12) Patent Application Publication
(10) Pub. No.: US 2008/0086264 A1
(43) Pub. Date: Apr. 10, 2008

(54) POPULARITY BASED GEOGRAPHICAL NAVIGATION

(75) Inventor: Danyel A. Fisher, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/539,184

(22) Filed: Oct. 6, 2006

(51) Int. Cl. G01C 21/30

(52) U.S. Cl. 701/209

(57) ABSTRACT

Typically, users click or otherwise show interest in a particular geographic region on a map to indicate their desire to center and/or zoom in on that location. However, it is more likely that a user has a higher interest in popular points of interest in a region than with a point of selection on a map. By employing popularity map data, the map navigation can be biased towards popular points of interest relative to a user's selection. This allows users to more effectively navigate through maps, rather than through trial and error selections based solely on geography. Some instances utilize weighting of popularity points to determine an offset distance from a user's selection. Other instances can employ a most popular point nearest a user's selection as a bias point. Included popularity points for biasing can be determined based on a percentage of a visualized map image presented to a user.

### RELATED APPLICATIONS

This application is related to co-pending and co-assigned U.S. application entitled “REPRESENTATION AND DISPLAY OF GEOGRAPHICAL POPULARITY DATA,” client reference MS317630.01, filed on Aug. 28, 2006 and assigned Ser. No. 11/467,789 and is incorporated herein by reference.

### BACKGROUND

Users interact with software in a myriad of ways that implicate geographical aspects. There are varieties of ways in which users might express such geographical interests or intent, which either explicitly or implicitly specify an interest in some part of the physical real world outside of virtual computing space. These can include searching for maps, browsing between locations, and examining geographically-based data.

However, not all geographical locations and regions are of equal interest to any user; nor is the aggregate interest of all users equally-distributed. Rather, the collective interest—the “popularity”—of places varies substantially depend on the users' interests and uses for technologies. While a user knows this intuitively based on real-world experiences, in contrast, computing devices do not have a native intelligence of these inequalities. Today, this information is unavailable to software applications, such as mapping and search software programs. Users typically navigate using a mouse pointer to repeatedly click on a map until they zoom into their desired point of interest. The clicking is generally based solely on geographical aspects rather than any underlying popular points of interest which may be of interest to a user. This means that users must find their own geographical points of interest without having popularity data to assist in their navigation, increasing the steps required to navigate through maps. In particular, the user is not able to use the past experience of other searchers to accelerate their own navigation.

### SUMMARY

Popularity map data is utilized to better predict where users truly desire to navigate rather than relying strictly on where a user geographically navigates. Typically, users click or otherwise show interest in a particular geographic region on a map to indicate their desire to center and/or zoom in on that location. However, it is more likely that a user has a higher interest in popular points of interest in a region than with a point of selection on a map. By employing popularity map data, the map navigation can be biased towards popular points of interest relative to a user's selection. This allows users to more effectively navigate through maps, rather than through typical trial and error selections based solely on geography. Some instances utilize weighting of popularity points to determine an offset distance (i.e., bias) from a user's selection. Other instances can employ a most popular point nearest a user's selection as a bias point. Included popularity points for biasing can be determined, for example, based on a percentage of a visualized map image presented to a user and the like.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a popularity biased navigation system in accordance with an aspect of an embodiment.

FIG. 2 is another block diagram of a popularity biased navigation system in accordance with an aspect of an embodiment.

FIG. 3 is yet another block diagram of a popularity biased navigation system in accordance with an aspect of an embodiment.

FIG. 4 is an illustration of a visualized map region with map center marks in accordance with an aspect of an embodiment.

FIG. 5 is an illustration of a visualized map region with a popularity map overlaid in accordance with an aspect of an embodiment.

FIG. 6 is a flow diagram of a method of assisting digital map navigation in accordance with an aspect of an embodiment.

FIG. 7 is another flow diagram of a method of assisting digital map navigation in accordance with an aspect of an embodiment.

FIG. 8 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Map navigation is enhanced by employing popularity data in conjunction with user and/or system selections of a visualized map region. This substantially reduces navigation errors by biasing selections based on proximate popularity points. Thus, selections are influenced by most likely points of interest rather than based on approximate geographical selections. Users and/or systems are then guided towards more interesting geographical regions without additional selections being necessary, greatly enhancing the navigation experience. Instances provided herein can utilize, for example, weighted and/or normalized popularity points and the like to determine a bias distance from a selection point.

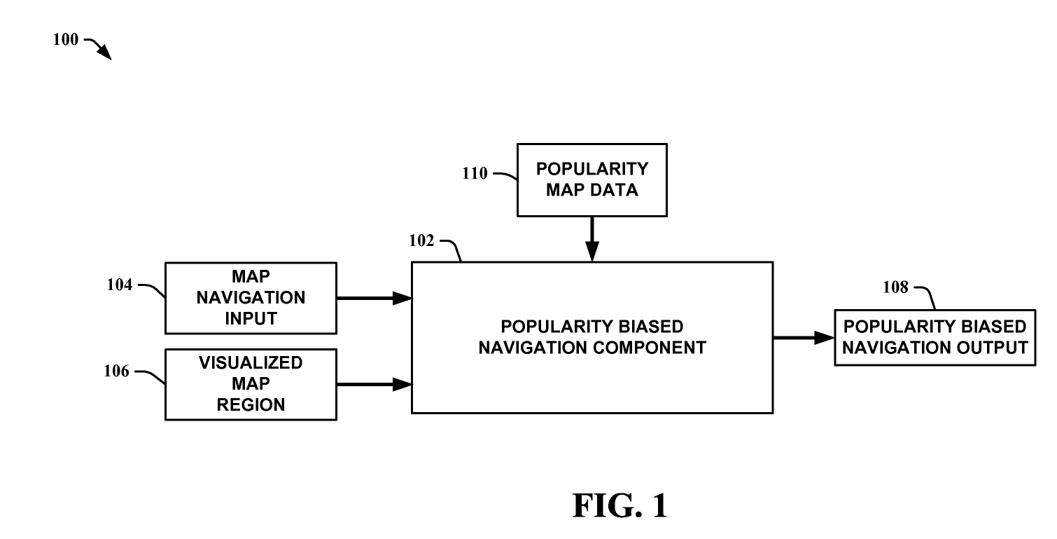

FIG. 1 illustrates a popularity biased navigation system 100 that employs a popularity biased navigation component 102 to receive map navigation input 104 and visualized map region 106 and provide popularity biased navigation output 108. The popularity biased navigation component 102 utilizes popularity map data 110 to bias map navigation towards popular points of interest. The visualized map region 106 is typically a partial display of a larger map in which a user and/or system is interested in viewing. A user typically centers, pans, and/or zooms the visualized map region 106 until it displays geographical detail desired by the user. The changing of the visualized map region 106 is generally accomplished by, for example, a pointing device such as, for example, a computer cursor controlled via, for example, a computer mouse, a touchpad, and/or a rollerball and the like. In some instances, it is not necessary for a user to actually make a selection via a mouse click, etc. The selection can be accomplished, for example, by hovering a cursor and the like and/or pausing eye movement over an area, etc. and/or clicking on “zoom” and/or “center,” etc. to control a visualized map. It can be appreciated that other means to control a pointing device such as a cursor can include eye movement, head movement, environmental indicators, and/or thought processes and other forward thinking based technologies.

The map navigation input 104 encompasses input data that represents selection information from the visualized map region 106. The map navigation input 104 can include, but is not limited to, selection information relative to a given visualized map region 106 (e.g., a coordinate or grid system based on the visualized map region 106, etc.) and/or selection information that contains information independent of the visualized map region 106 (e.g., standardized coordinates such as latitude/longitude, etc.). Thus, instances of the popularity based navigation component 102 disclosed herein may or may not require the visualized map region 106 to determine geographic location of the map navigation input 104.

The popularity map data 110 is comprised of data that represents popular points of interest relative to a geographical map. The determination of this type of data is disclosed in United States patent application “REPRESENTATION AND DISPLAY OF GEOGRAPHICAL POPULARITY DATA,” filed on Aug. 28, 2006 and assigned Ser. No. 11/467,789 and is incorporated herein by reference. The popularity biased navigation component 102 processes the popularity map data 110 to determine popular points near the map navigation input 104.

Acceptable popularity map data 110 can be based on a proximity threshold value. In one instance, the proximity threshold value is based on a percentage of the visualized map regions 106. Thus, for example, an area of approximately 10% of the visualized map region 106 can be utilized as the proximity threshold value for finding a relevant subset of the popularity map data 110 in proximity to the map navigation input 104. Determination of the proximity threshold value is discussed in detail infra. The popularity biased navigation component 102 can then employ this subset to bias navigation from the map navigation input 104 towards the subset of popularity map data 110. Biasing techniques are discussed in detail infra.

Thus, by utilizing at least a part of the popularity map data 110, the popularity biased navigation component 102 can provide the popularity biased navigation output 108 to assist in navigation of the visualized map region 106. This substantially increases user satisfaction by biasing a visualized map region towards more interesting points of popularity rather than strictly towards a geographical location. Users no longer have to “guess” in their navigation to reach points that they are most likely to be interested in. Other instances, described infra, allow users and/or systems to further influence what popular points they are interested in, how large a proximity area to employ, and/or how much biasing is accomplished and the like.

The popularity biased navigation output 108 is typically employed in map viewing systems to guide a visualized map region for a user and/or system. Some instances described herein, however, can be utilized standalone and/or for other types of systems and the like. For example, a user can make a map selection and rather than the end result being a redrawing of a visualized map region based on their selection, a listing of restaurants and/or attractions and the like could be posted for the user and/or included on a map and the like.

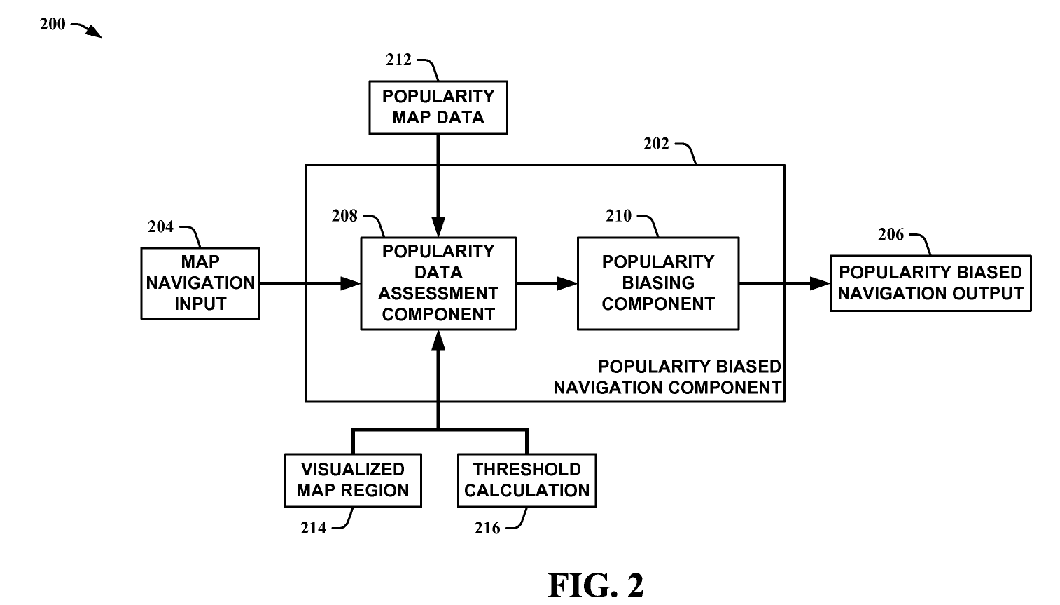

Another instance of a popularity biased navigation system 200 which utilizes a popularity biased navigation component 202 to bias a map navigation input 204 based on popularity map data 212 to provide a popularity biased navigation output 206 is shown in FIG. 2. The popularity biased navigation component 202 employs a popularity data assessment component 208 and a popularity biasing component 210 to determine the popularity biased navigation output 206. The popularity data assessment component 208 obtains the map navigation input 204 along with a corresponding visualized map region 214 and threshold calculation 216. The visualized map region 214 and map navigation input 204 allow the popularity data assessment component 208 to determine a desired geographic selection that can be associated to the popularity map data 212. The popularity data assessment component 208 utilizes the threshold calculation 216 to derive a subset of the popularity map data 212 that falls within a threshold value for the map navigation input 204. The threshold calculation 216 can be based on the visualized map region 214 (e.g. a percentage of the visualized map region 214, etc.), on a fixed area about the map navigation input 204, and/or on inclusion of a particular amount and/or type of popularity map data 212 and the like (e.g., the top five amusement attractions within the visualized map region 214, all amusement attractions within 5 miles of the map navigation input 204, etc.). In this manner, the popularity data assessment component 208 provides the popularity biasing component 210 with the subset of the popularity map data 212 and the map navigation input 204.

The popularity biasing component 210 then processes the popularity map data 212 to derive a bias for the map navigation input 204. The bias can be based on, for example, a weighting of the subset data and/or a determination of a single point of highest popularity and the like. User and/or system preferences and the like can be employed as well to influence the biasing. It can be appreciated that other algorithms and statistical models not detailed herein can also be employed by the popularity biasing component 210 to derive the bias. The bias can be an offset distance from the map navigation input 204 with a direction towards a statistical and/or a geographical location and the like of the subset of the popularity map data 212. The distance can be based on the amount of influence, user preference, popularity, and/or type of data and the like. For example, if a strong preference is shown for amusement parks and the subset data is composed of mainly popular amusement attractions, the biasing can substantially influence map navigation in the direction of the subset data. With lesser interest, the biasing towards the subset data can be reduced.

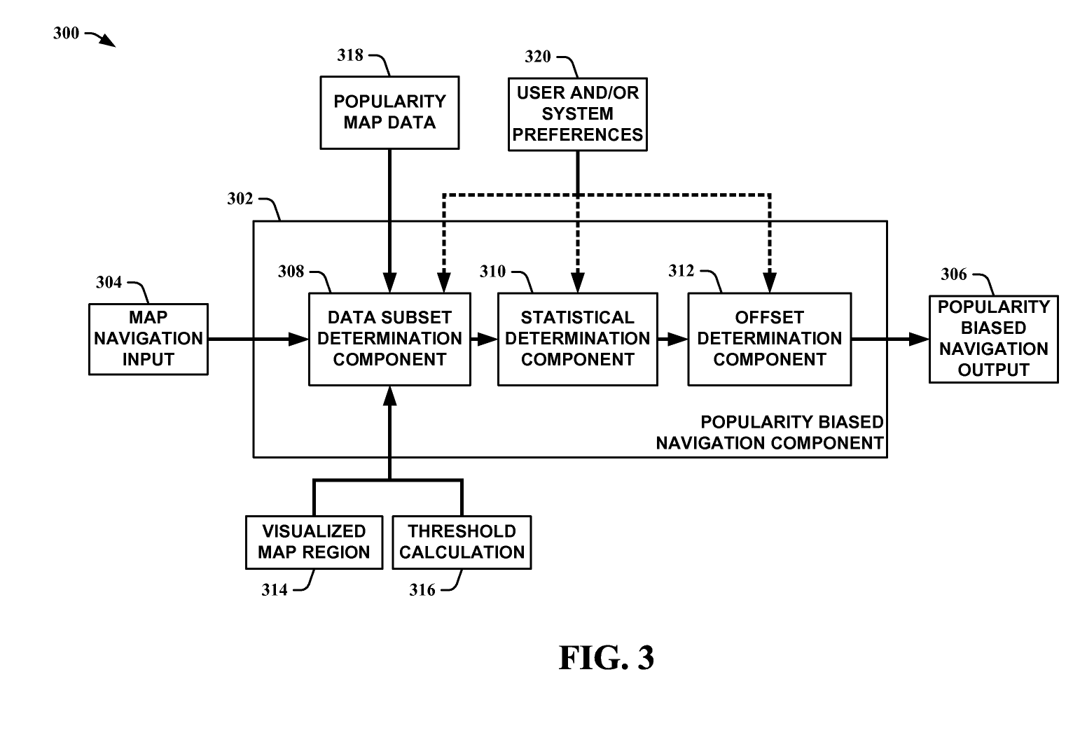

FIG. 3 depicts a popularity biased navigation system 300 that utilizes a popularity biased navigation component 302 to derive a popularity biased navigation output 306 based on a map navigation input 304 and popularity map data 318. The popularity biased navigation component 302 accomplishes this by utilizing a data subset determination component 308, a statistical determination component 310, and an offset determination component 312. The data subset determination component 308 receives the map navigation input 304 along with an associated visualized map region 314. The data subset determination component 308 then employs a threshold calculation 316 to determine a subset of the popularity map data 318 that represents popularity points associated with the map navigation input 304 and within the threshold calculation 316.

The data subset determination component 308 can also employ optional user and/or system preferences 320 to influence determination of the subset data. For example, a user can dictate that they are interested in popularity data surrounding five square miles of the map navigation input 304. Or, for example, a user can indicate that they prefer restaurant popularity data to be utilized to determine the subset data based on their map navigation input 304. Thus, users and/or systems can influence, at a minimum, what popularity map data 318 to process, what portion of the visualized map region 314 to consider, and/or what threshold calculation to employ and the like.

The statistical determination component 310 receives the subset data from the data subset determination component 308 and processes the subset data to determine a statistical center point for the subset data. The statistical center point can be derived based on geographical location of popularity points within the subset data and/or level of popularity of the popularity data and/or type of popularity data within the subset data. In a very simplistic example, the most popular point within the subset data can be employed as a statistical center point. The statistical determination component 310 can also employ optional user and/or system preferences 320 to influence the statistical determination of the statistical center point. Thus, for example, a user can dictate what algorithm and/or technique is utilized in determining the statistical center point. It can be appreciated that other statistical processes not disclosed herein can also be employed by the statistical determination component 310 to derive a statistical center point for the subset data.

The offset determination component 312 utilizes the statistical center point and the map navigation input 304 to derive an offset or bias. The offset or bias is typically a distance from the map navigation input 304 in a direction towards the statistical center point. The distance can be influenced by the relevancy of the subset data popularity, a predetermined distance, optional user and/or system preferences 320, and/or distance between the statistical center point and the map navigation input 304 (e.g. the farther away a statistical center point is from the map navigation input 304, the greater the biasing, etc.) and the like. It can be appreciated that other techniques can be utilized by the offset determination component 312 as well to determine offset/biasing. The offset determination component 312 then utilizes the derived offset/biasing to provide the popularity biased navigation input 306. The popularity biased navigation input 306 can be utilized to re-center, zoom, and/or pan and the like the visualized map region 314. Thus, even without direct input from a user and/or system, the visualized map region 314 is influenced by the popularity map data 318, substantially increasing the performance of the navigation process and/or the satisfaction of users of the navigation process.

The above systems and instances disclosed herein allow the use of popularity data to facilitate geographical navigation. Traditionally, when users navigate within online mapping programs, they do not move uniformly—rather, they tend to move toward the most popular places on the map. (Disneyland, for example, is more popular than Downey, Calif.; Seattle is more popular than Bainbridge Island.) Despite this, existing mapping programs use either the “center” of the map or the current location of the mouse pointer to navigate. This results in users who have slightly missed their targets from navigating to their destination—they need to add extra steps of panning and moving about to reach their desired goal. However, by utilizing instances disclosed herein, probabilistic predictions can made on where a user intends to navigate to, based on where other users have looked in the past. With this knowledge, for example, the zoom operation can be tweaked slightly toward the nearest, most popular area to assist a user in zooming into their actual destination. Thus, collective past behavior can be employed to help users navigate toward places that are most desirable.

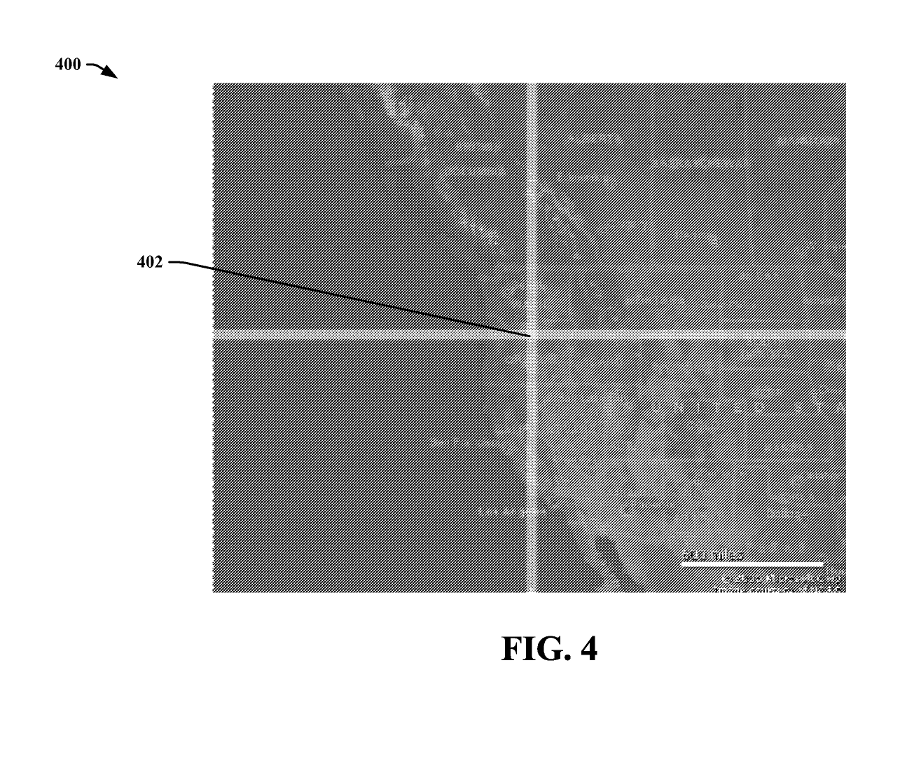

Past navigation information (e.g. from web usage logs, etc.) is utilized to calculate the relative “popularity” of points on a map (see, REPRESENTATION AND DISPLAY OF GEOGRAPHICAL POPULARITY DATA). The instances disclosed herein utilize these popularity maps. Given such a popularity map, an area near where a user has selected to navigate can be examined. Thus, for example, assume a user is looking at a broad view of the United States, with the scene centered somewhere near the Cascade Mountains. A popularity map can (see, FIG. 4—an illustration of a visualized map region 400 with map center marks 402) show that Seattle, Vancouver, and Portland are the most popular points near where the screen is centered. When the user selects, for example, “zoom in on center,” a subset of popular points that are within a distance threshold t are selected. In this example, the cities named above are all within 10% of the screen's size from the center.

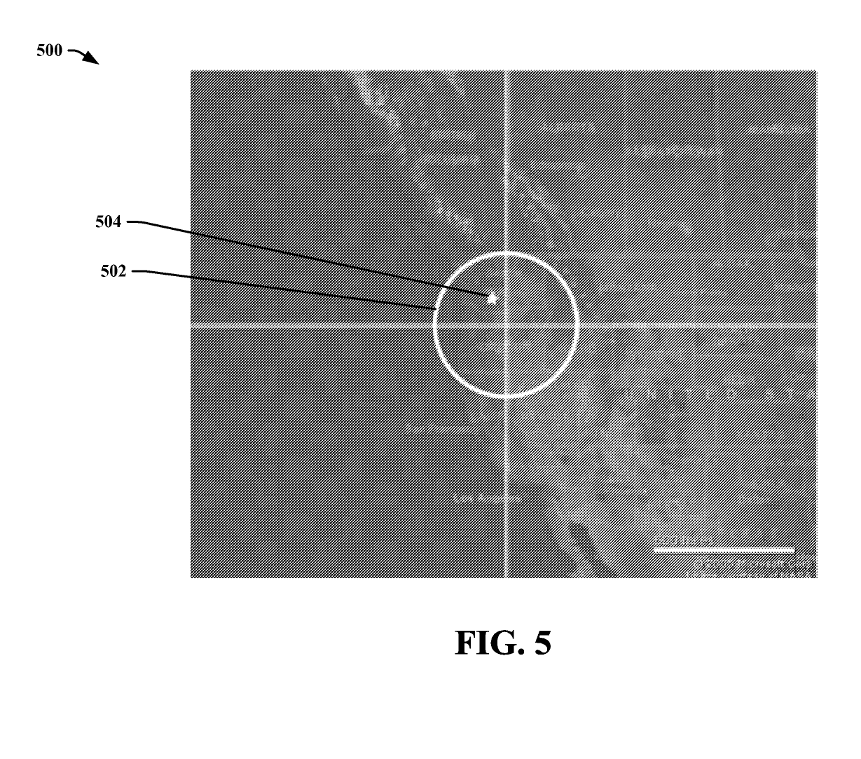

For example, a weighted average of the nearest, most popular points can then be chosen. In this example, an algorithm can specify that the zoom point should move only toward the most popular point, Seattle (see, FIG. 5—an illustration of a visualized map region 500 with a popularity map overlaid. A circle 502 indicates “popular spots within 10% of the screen size” and a star 504 indicates the new center point.). The screen is then moved some distance d toward that weighted center. In this example, the algorithm specifies that navigation move to half-way between the current point and the desired one and then zooms in at that new center. This encourages a user toward the point they wish to reach, without requiring serious and repeated adjustments. If users did not, in fact, want to zoom in on that center, they can simply compensate by pushing off-center slightly and/or turning the process off, etc. As long as d is small, this is typically an undetectable change to the user—other than more efficient navigation.

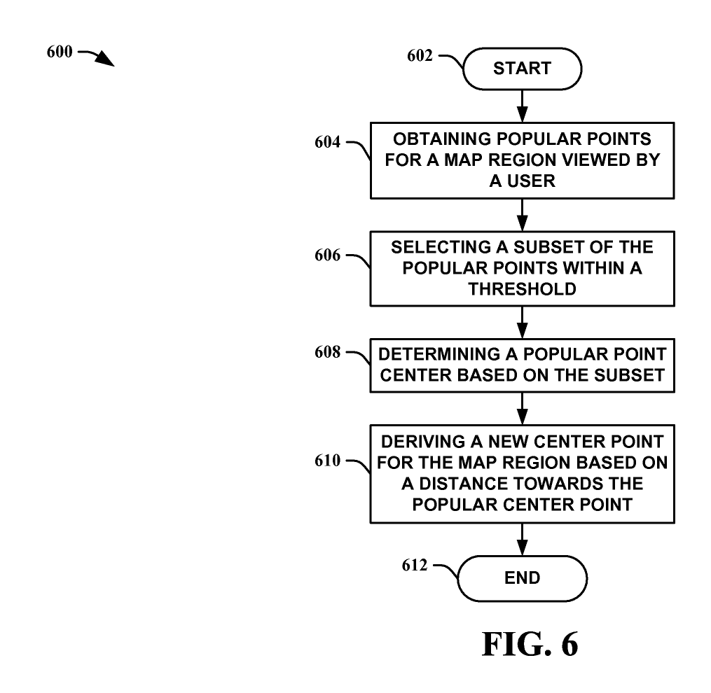

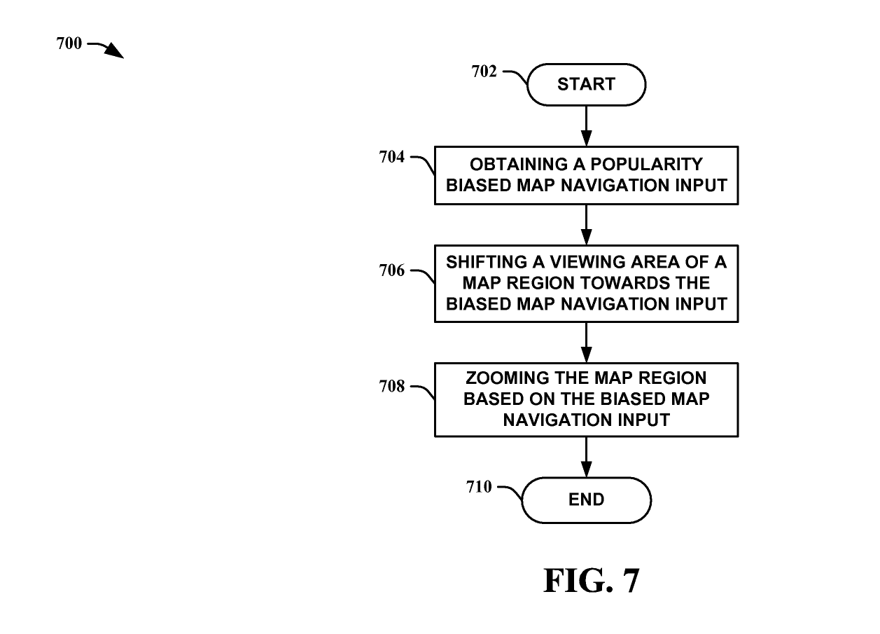

In view of the exemplary systems shown and described above, methodologies that may be implemented in accordance with the embodiments will be better appreciated with reference to the flow charts of FIGS. 6 and 7. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 6, a flow diagram of a method 600 of assisting digital map navigation in accordance with an aspect of an embodiment is shown. The method 600 starts 602 by obtaining popular points for a map region viewed by a user 604. The creation of this type of data is disclosed in United States patent application “REPRESENTATION AND DISPLAY OF GEOGRAPHICAL POPULARITY DATA,” filed on Aug. 28, 2006 and assigned Ser. No. 11/467,789 and is incorporated herein by reference. The popular points represent collective past data that is typically derived from user behavior with regard to navigating to points on a map. The popular points can be of any variety such as popular restaurants, scenic areas, most people, amusement parks, live entertainment areas, most free transportation, and/or theater areas and the like to name but a few. How often prior users selected these points based upon their interests is collected and assembled into popularity map data which can be obtained from, for example, a popularity map data server via an Internet and/or other global connection and the like.

A subset of the popular points within a threshold is then selected 606. In one instance a threshold calculation can be utilized to determine the subset of the popularity points. Optional user and/or system preferences can also be employed to influence determination of the subset data. For example, a user can dictate that they are interested in popularity data five square mile area. Or, for example, a user can indicate that they prefer restaurant popularity points to be utilized to determine the subset data. Thus, users and/or systems can influence, at a minimum, what popularity points to process, what area to consider, and/or what threshold calculation to employ and the like.

A popular point center based on the subset is then determined 608. The subset of the popular points is typically utilized to derive a statistical popular center point for the subset data. The popular point center point can be determined based on geographical location of popularity points within the subset data and/or level of popularity of the popularity data and/or type of popularity data with the subset data and the like. In a very simplistic example, the most popular point within the subset data can be employed as a popular center point. Optional user and/or system preferences can also be employed to influence the determination of the popular center point. Thus, for example, a user can dictate what algorithm and/or technique is utilized in deriving the popular center point. It can be appreciated that other processes not disclosed herein can also be employed to derive a popular center point for the subset data.

A new center point for the map region based on a distance towards the popular center point is then derived 610, ending the flow 612. The distance can be influenced by the relevancy of the subset data popularity, a predetermined distance, optional user and/or system preferences, and/or distance between a popular center point and a user selection (e.g., the farther away a popular center point is from a user selection, the greater the distance, etc.) and the like. It can be appreciated that other techniques can be utilized to determine the distance as well. The new center point can be utilized to re-center, zoom, and/or pan and the like a map region. Thus, even without direct input from a user and/or system, the map region is influenced by popular point data, substantially increasing the performance of a navigation process and/or the satisfaction of users of a navigation process.

Turning to FIG. 7, another flow diagram of a method 700 of assisting digital map navigation in accordance with an aspect of an embodiment is illustrated. The method 700 starts 702 by obtaining a popularity biased map navigation input 704. The popularity biased map navigation input is obtained from processes described supra. It represents a navigation input biased by popularity map data and can be employed to influence map navigation. A viewing area of a map region is then shifted towards the biased map navigation input 706. This can be accomplished in an automated fashion such that after a user indicates, via a selection (mouse click, etc.), a desired map location, the map can shift towards the biased map navigation input. The map region is then zoomed based on the biased map navigation input 708, ending the flow 710. In a similar fashion, the zooming can be achieved in an automated manner such that the user only has to indicate a desired map selection and the map is shifted and zoomed automatically based on the biased map navigation input.

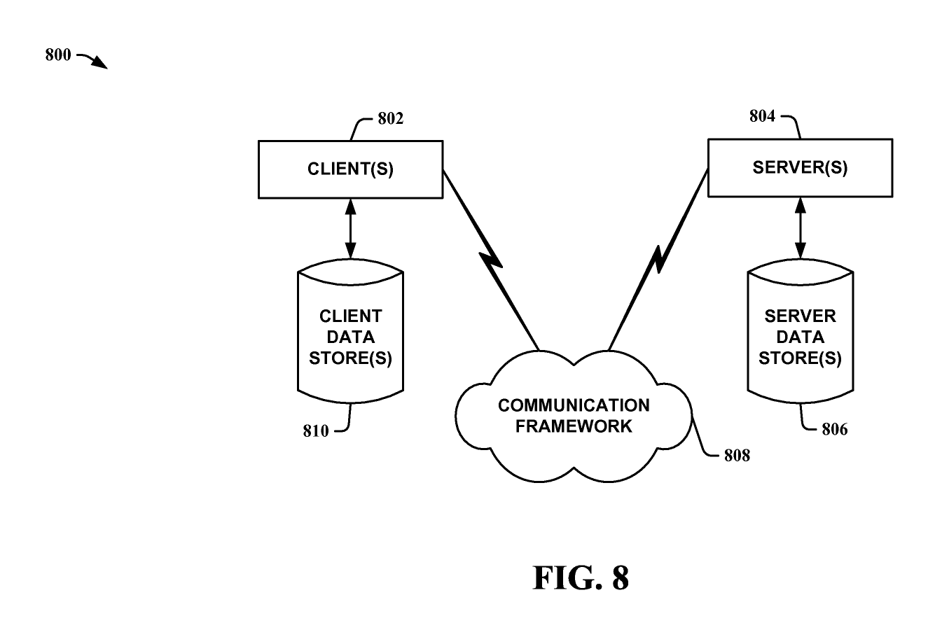

FIG. 8 is a block diagram of a sample computing environment 800 with which embodiments can interact. The environment 800 further illustrates a system that includes one or more client(s) 802. The client(s) 802 can be hardware and/or software (e.g., threads, processes, computing devices). The environment 800 also includes one or more server(s) 804. The server(s) 804 can also be hardware and/or software (e.g., threads, processes, computing devices). In one instance, the server(s) 804 can provide popularity map data to a map navigation system and/or method residing on a client(s) 804. One possible communication between a client 802 and a server 804 can be in the form of a data packet adapted to be transmitted between two or more computer processes. The system 800 includes a communication framework 808 that can be employed to facilitate communications between the client(s) 802 and the server(s) 804. The client(s) 802 are connected to one or more client data store(s) 810 that can be employed to store information local to the client(s) 802. Similarly, the server(s) 804 are connected to one or more server data store(s) 806 that can be employed to store information local to the server(s) 804.

It is to be appreciated that the systems and/or methods of the embodiments can be utilized in map navigation facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that enhances map navigation, comprising:
a popularity data assessment component that receives popularity map data corresponding, at least in part, to a visualized map region and derives a subset of the popularity map data based on, at least in part, a map navigation input and the visualized map region; and
a popularity biasing component that employs the popularity map data subset to bias the map navigation input.

2. The system of claim 1, the popularity biasing component employs a weighted average of nearest popular points from the popularity map data subset to determine the map navigation input biasing.

3. The system of claim 1, the popularity biasing component employs a single most popular point from the popularity map data subset to determine the map navigation input biasing.

4. The system of claim 1, the popularity data assessment component determines the popularity map data subset based on a threshold.

5. The system of claim 4, the threshold derived from a percentage of the visualized map region.

6. The system of claim 4, the threshold derived based on a minimum level of popularity of popular points in the popularity map data.

7. The system of claim 1, the map navigation input comprising a system and/or user map center request and/or map zoom request on a geographical map location.

8. The system of claim 1, the popularity data assessment component determines the popularity map data subset based on, at least in part, user and/or system preferences for types of popularity data.

9. The system of claim 1, the popularity biasing component utilizes a bias based on user and/or system preferences for popularity map data utilized in the popularity map data subset.

10. A method for assisting digital map navigation, comprising:
obtaining popular points for a map region viewed by a user;
selecting a subset of the popular points within a threshold;
determining a popular point center based on the subset; and
deriving a new center point for the map region based on a distance towards the popular center point.

11. The method of claim 10 further comprising:
shifting a viewing area of the map region towards the new center point; and
zooming the map region based on the new center point.

12. The method of claim 10 further comprising:
determining the popular point center based on a single most popular point of the subset and/or a weighted average of nearest popular points of a visual center point of the map region from the subset.

13. The method of claim 10 further comprising:
determining the threshold based on a percentage of a viewable portion of the map region.

14. The method of claim 10 further comprising:
determining the threshold based on a user and/or system preference.

15. The method of claim 10 further comprising:
determining the distance based on a normalized strength level of the subset of popular points.

16. The method of claim 10, the popular points based on prior collective user navigation behavior information.

17. A system that augments map navigation, comprising:
means for receiving popularity map data corresponding, at least in part, to a visualized map region;
means for deriving a subset of the popularity map data based on, at least in part, a user's geographical map selection point and the visualized map region; and
means for utilizing the popularity map data subset to bias the user's geographical map selection point.

18. A computer readable medium having stored thereon computer executable components of the system of claim 1.

19. A device employing the method of claim 10 comprising at least one selected from the group consisting of a computer, a server, and a handheld electronic device.

20. A device employing the system of claim 1 comprising at least one selected from the group consisting of a computer, a server, and a handheld electronic device.
